(19) United States
(12) Patent Application Publication
(10) Pub. No.: US 2026/0269106 A1
(43) Pub. Date: Sep. 10, 2026

(54) METHOD FOR PRODUCING A SHIELDED CABLE

(71) Applicants: Schleuniger AG, Thun (CH); LISA DRÄXLMAIER GMBH, Vilsbiburg (DE)

(72) Inventors: Robert Bruckmoser, Weng (DE); Kevin Nowak, Eching (DE); Thierry Elsner, Wald ZH (CH); Reto Sandhofer, Merenschwand (CH); Manfred Petermann, Buchrain (CH)

(21) Appl. No.: 19/165,395

(22) PCT Filed: Mar. 14, 2024
(86) PCT No.: PCT/EP2024/056785

§ 371 Date: Sep. 15, 2025

(30) Foreign Application Priority Data
Mar. 17, 2023 (DE) 10 2023 106 759.1

(51) Int. Cl. H01B 13/22

(52) U.S. Cl. CPC H01B 13/22

(57) ABSTRACT

A method for producing a shielded line, including the following steps: providing a conductor with a shield braid which is arranged around an outer circumferential surface of the conductor and has a plurality of shield strands, opening the shield braid such that the shield strands of the shield braid are no longer braided in the region of a free end of the shield strands, positioning the free end of the shield strands of the opened shield braid such that the free end extends away from the conductor in a substantially radial direction, separating out the positioned free end of the shield braid by means of a splitting device such that in the shield braid a gap is produced which subdivides the plurality of shield strands or spaces them apart from one another in groups, placing a crimping sleeve around the outer circumferential surface of the conductor and around the shield braid such that a joining portion comes to lie between two free radial ends of the crimping sleeve in the region of the gap of the shield braid, and crimping on the placed crimping sleeve by means of a crimping tool.

### TECHNICAL FIELD

The present invention relates to a method for producing a shielded cable, a shielded cable produced thereby, a device for producing a shielded cable and a splitting device.

### BACKGROUND

Shielded cables are used in many different ways, for example in automotive engineering, where electromagnetic influences, crosstalk or similar effects are to be reduced or avoided by using shielded cables.

To manufacture such shielded cables, such as coaxial cables, etc., a support sleeve or an outer conductor can be attached around a shielding braid with shield strands of the shielded cable using a crimping process. The support sleeve or the outer conductor can in principle represent a partially open crimp sleeve with free ends. The free ends of the crimp sleeve can also be referred to as crimp flanks and are brought together by the crimping process to close the crimp sleeve without overlapping but rather lie butt to butt. However, this leaves at least a minimal gap between the crimp flanks through which part of the shielding braid, e.g., individual shield strands, can protrude from the crimp sleeve, i.e., from the support sleeve or from the outer conductor, in the area of the gap. This protruding part of the shielding braid cannot be detected consistently or reliably due to, for example, the fineness of the shield strands, the associated testing effort, etc. As a result, loose shield strands, a short circuit, or other quality deterioration of the shielded cable may occur.

### SUMMARY

An object of the invention is therefore to reduce or avoid the protrusion of the shielding braid, in particular of shield strands thereof, using means that are as simple as possible in terms of construction, in order to provide a shielded cable of higher quality.

This object is achieved by the subject matter of the independent claims. Advantageous developments of the invention are specified in the dependent claims, the description and the accompanying figures.

A method for producing a shielded cable is proposed. The method comprises the following steps: providing a conductor with a shielding braid that is arranged around an outer circumferential surface of the conductor and has a plurality of shield strands, opening the shielding braid so that the shield strands of the shielding braid are no longer braided in the region of a free end of the shield strands, setting up the free end of the shield strands of the opened shielding braid such that the free end extends away from the conductor in a substantially radial direction, spreading apart the set-up free end of the shielding braid by means of a splitting device such that a gap is created in the shielding braid that divides the plurality of shield strands and/or spaces them apart in groups, folding over the shield strands for or applying a crimp sleeve around the outer circumferential surface of the conductor and around the folded-over shield strands or around the shielding braid such that a joining portion of the crimp sleeve between two free radial ends of the crimp sleeve comes to lie in the region of the gap of the shielding braid, and crimping the applied crimp sleeve by means of a crimping tool, in particular while reducing or avoiding the inclusion of protruding shield strands by the joining portion. The crimping tool can be a known crimping tool.

The shielded cable may be a cable having at least one inner conductor, an insulation, and a shielding braid, wherein the shielding braid may be arranged around an outer peripheral surface of the insulation of the conductor and may have a plurality of shield strands.

This can at least reduce the amount of shield strands protruding from the support sleeve or crimp sleeve. This can reduce the proportion of rejected parts, which can result in cost savings, process improvements, etc. In particular, loose shield strands and the resulting short circuits can be avoided.

The shielded cable to be manufactured can be, for example, a coaxial cable, RF coaxial cable or similar. This can transmit radio frequency (RF) signals from one point to another. Such a cable can be used, for example, in a motor vehicle or similar applications. The coaxial cable can in essence comprise several layers, namely an inner conductor, i.e., the conductor described herein, which can be a copper wire through which signals can be transmitted, a dielectric plastic insulator arranged around the copper wire, a shielding braid, i.e., a braided network of shield strands, which are made of copper or another conductive material, for example, which protects the conductor from electromagnetic interference and optionally serves as a second conductor, and a plastic coating as an outer layer (jacket), which protects the inner layers from damage and electrically insulates them. In addition, the cable to be manufactured here has an outer conductor in the form of the support sleeve or crimp sleeve.

The crimp sleeve can be conductively connected to the shielding braid during operation, which can be achieved through the crimping process.

The shielding braid can also include shield strands that are not braided together or can consist of such. The shield strands can also be arranged around the dielectric plastic insulator in a different way, for example parallel to each other or interwoven.

As used herein, the joining portion between the two free radial ends of the crimp sleeve can be understood to mean that in the crimped state of the crimp sleeve, the free ends of the same are arranged butt to butt, if necessary, with a negligible gap, e.g., straight or corrugated, particularly with regard to electromagnetic properties.

The splitting device can be immersed into the set-up shielding braid in order to specifically split it, i.e., to space adjacent shield strands from each other by plastic bending. The resulting distance can/should be substantially maintained by the shield strands when the splitting device is removed. The resulting gap between the shield strands can be brought into line, i.e., overlap, with the joining portion of the crimp sleeve. This means that the joining portion and the gap can/should be aligned in the radial direction relative to the cable. The split shield strands can/should be bent by the splitting device and thus maintain the gap.

The setting up of the free ends of the shielding braid can be understood as meaning that these extend away from the cable or conductor in a radial direction, i.e., outwards from the conductor, in relation to a longitudinal extension of the cable or conductor. The setting up can be carried out, for example, by guiding the conductor together with the shielding braid against a set-up device, or conversely by guiding the set-up device against the shielding braid, wherein the free ends of the shielding braid abut against the set-up device and are thereby bent and brought into the erected shape. However, the setting up can also be carried out using other, known methods, such as compressed air or brushes.

According to a development, the plurality of shield strands can be divided by the spreading apart into a first subgroup extending over a first arc portion of the outer peripheral surface of the conductor and into a second subgroup extending over a second arc portion of the outer peripheral surface of the conductor, and the gap between the first and second subgroups extends over a third arc portion of the outer peripheral surface of the conductor.

This makes it particularly easy to ensure that the shielding braid is split where the crimp flanks, i.e., the free ends of the crimp sleeve, are brought butt to butt, i.e., joined together, so that the corresponding area is at least largely free of shield strands.

In a development, the method further comprises the step of folding over the free end of the shielding braid with a gap such that the free ends of the shielding braid are directed away from a free end of the conductor in opposite directions.

This can be done with the help of the set-up device for setting up the shield strands or a stripping device for stripping the shield strands before applying the crimp sleeve, or by means of a crimp sleeve during the application of the crimp sleeve.

This allows the shielding braid provided with a gap to be applied to the conductor and thus prepared for the application of the crimp sleeve or to be brought into its final position during the application of the crimp sleeve. The gap previously formed in the shielding braid is retained, wherein the crimp sleeve can/should be attached to it in such a way that the joining portion of the crimp sleeve is arranged in the area of the gap.

According to a development, the free ends of the shield strands of the shielding braid can be positioned at a substantially perpendicular angle to a longitudinal extension direction of the conductor. This prepares the shielding braid well for the insertion of the splitting device into it.

In a development, the splitting device can have a bow shape, wherein the splitting device is inserted with a tip of the bow first between the free ends of the shield strands of the shielding braid.

The bow can be tapered in the tip area and become increasingly wider or thicker from there. The tip facilitates penetration between the relatively fine shield strands, wherein the further penetration of the growing bow facilitates the formation of the gap.

According to a development, the crimp sleeve in conjunction with the shielding braid can form an outer conductor of the cable or a part of the outer conductor. With this type of cable, it is advantageous if as few or none of the shield strands as possible protrude from the crimp sleeve or from its joining portion.

In a development, the method further comprises the step: after crimping the crimp sleeve, optically checking the joining portion for shield strands protruding between the two free radial ends of the crimp sleeve and/or other processing errors. This can be done using a camera, an optical inspection by a technician, etc.

A device for producing a shielded cable is also proposed. The device can be a tool. The device comprises a holding device which is configured to hold a shielded cable at its outer circumference. The device further comprises at least one set-up device which is configured to set up a shielding braid which is arranged around an outer circumferential surface of a conductor of the shielded cable and has a plurality of shield strands, such that free ends of the shield strands of the shielding braid extend away from the conductor in a substantially radial direction. In addition, the device comprises a splitting device which is configured to spread apart the set-up free ends of the shield strands in such a way that a gap is created in the shielding braid which divides the plurality of shield strands and/or spaces them apart from one another in groups. Furthermore, the device comprises a crimping device which is configured to apply a crimp sleeve around the outer circumferential surface of the conductor and around the shielding braid in such a way that a joining portion between two free radial ends of the crimp sleeve comes to lie in the region of the gap in the shielding braid, and to crimp the crimp sleeve.

The proposed device can be used to implement the method described above. The cable produced in this way has either no or a reduced number of shield strands protruding from the crimp sleeve, since the splitting of the shielding braid and the arrangement of the resulting gap in the area of the joining portion of the crimp sleeve at least largely prevents shield strands from being present there when the crimp sleeve is crimped onto the cable or conductor.

The individual devices, i.e., the parts of the device, such as the holding device, the set-up device, the splitting device and the crimping device, can each have a suitable actuator for actuation, which can be controlled by a controller. In addition, the individual devices can be provided and/or arranged separately from one another or combined to form an integrated device.

According to a development, the splitting device can have a bow shape, wherein the splitting device can be configured to be inserted into the free end of the shielding braid with a bow tip of the bow first or to dip therein. The bow is tapered in the tip area and becomes increasingly wider and thicker from there. The tip facilitates penetration between the relatively fine shield strands, wherein the further penetration of the growing bow facilitates the formation of the gap.

The shape of the splitting device can be modeled on the bow of a ship. That is, the splitting device may have a point, possibly with a radius, and an edge extending in a curvature in a direction away from the point. The bow tip can be this edge. The splitting device can widen away from this edge, in particular can widen again with a curvature. The shape of the splitting device can be based on a vertical bow from shipbuilding. Towards the point along the bow tip it can be concave and with a convex transition up to the component width of the splitting device.

In a development, the device can comprise a stripping device, wherein the stripping device is configured to fold over the free end of the shield strands of the shielding braid with a gap in such a way that the free ends of the shield strands of the shielding braid are directed away from a free end of the conductor, in particular are directed in the opposite direction.

The device for setting up, i.e., the set-up device, and the device for turning over the shield strands of the shielding braid, i.e., the stripping device, can be different devices or a single device. This allows the shielding braid provided with a gap to be applied to the conductor and thus prepared for the application of the crimp sleeve. The gap previously formed in the shielding braid can be retained, wherein the crimp sleeve can be attached to it in such a way that the joining portion of the crimp sleeve is arranged in the area of the gap.

The stripping device can also comprise the crimp sleeve or substantially consist of it. When fitting the crimp sleeve, the free ends of the shield strands of the shielding braid can be folded over accordingly. This can be done in particular by moving the crimp sleeve in a direction that extends from the free end of the cable along the longitudinal axis of the cable across the cable.

Also proposed is a splitting device for a device according to the type described above, wherein the splitting device has a bow shape which is designed such that the splitting device tapers concavely to a point along a bow tip and has a convex transition from the bow tip to the component width of the splitting device

Further features, advantages and possible applications of the invention will become apparent from the following description of advantageous embodiments and the accompanying figures.

### BRIEF DESCRIPTION OF THE DRAWINGS

Advantageous exemplary embodiments of the invention are explained below with reference to the accompanying figures. In the figures:

FIG. 1 shows a side view of a shielded cable with a crimp sleeve in a state before crimping according to an embodiment (but with the strands omitted from the drawing);

FIG. 2 shows a perspective view of a shielded cable with a crimp sleeve in a crimped state according to one embodiment;

FIG. 3 shows a schematic perspective view of a device for producing a shielded cable according to an embodiment;

FIG. 4 shows a perspective view of a device for producing a shielded cable according to an embodiment;

FIG. 5 shows a schematic perspective view of a device for producing a shielded cable according to an embodiment;

FIG. 6 shows a flowchart for a method for producing a shielded cable according to an embodiment;

FIG. 7 shows a further perspective view of the device for producing a shielded cable according to an embodiment;

FIG. 8 shows a further perspective view of the device for producing a shielded cable according to an embodiment;

FIG. 9 shows a further perspective view of the device for producing a shielded cable according to an embodiment; and FIG. 10 shows a schematic representation of an end of a shielded cable after spreading apart shield strands according to an embodiment.

The figures are merely schematic representations and serve only to explain the invention. Identical or equivalent elements are provided with the same reference signs throughout.

### DETAILED DESCRIPTION

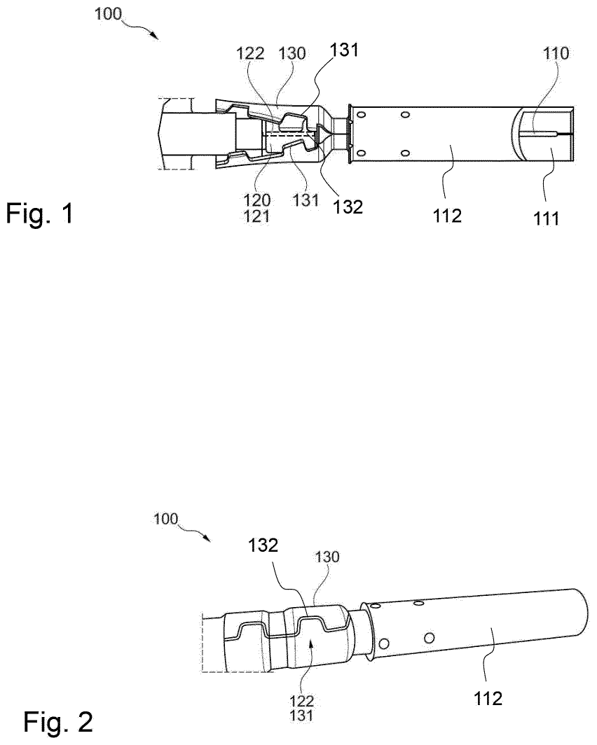

FIG. 1 shows a side view of a shielded cable 100, which may be, for example, a radio frequency (RF) cable. In FIG. 1, the cable 100 is shown in a partially finished state in order to explain the invention more clearly.

According to FIG. 1, the cable 100 has several layers, namely a conductor 110 or inner conductor, which can be a copper wire through which signals can be transmitted, an insulator 111, in particular a dielectric plastic insulator, which is arranged around the copper wire, a shielding braid 120, i.e., a braided network of shield strands 121, which are made, e.g., of copper or another conductive material, which protects the conductor 110 from electromagnetic interference, and an outer layer 112, in particular a plastic coating, which protects the inner layers, i.e., at least the conductor 110, the insulator 111 and the shielding braid 120, from damage.

In addition, the cable 100 to be produced here has an outer conductor in the form of a support sleeve or crimp sleeve 130. The crimp sleeve 130 has two ends facing each other, which can also be referred to as crimp flanks 131. The crimp flanks 131 can be two free radial ends 130 of the crimp sleeve 130. The crimp flanks 131 can have a serrated structure or a meander structure, which interlock when the crimp flanks 131 are brought together and form a joining portion 132 secured against axial shearing. In a further exemplary embodiment, the crimp flanks have no structure and are substantially flat.

In FIG. 1, a gap 122 formed in the shielding braid 120 is schematically indicated. In the gap 122, the shield strands 121 are divided and/or spaced apart from each other in groups. The gap 122 is arranged in position and/or location such that a joining portion 132 of the crimp sleeve 130, which is formed by bringing together the crimp flanks 131, is arranged in the region of the gap 122, e.g., overlapping therewith.

FIG. 2 shows the finished cable 100 in a perspective view. Compared to the illustration in FIG. 1, the crimp sleeve 130 is now crimped onto the cable in FIG. 2, whereby the crimp flanks 131 are now closed and are preferably arranged butt-to-butt with each other. The joining portion 132 of the crimp flanks 131 is located in the area of the gap 122, not visible here, which was previously introduced into the shielding braid 120. Therefore, here no or at least fewer shield strands 121 of the shielding braid 120 protrude into the joining portion 132 and also out of the crimped-on crimp sleeve 130 compared to an arrangement in which the joining portion 132 is not arranged in the region of the gap 122.

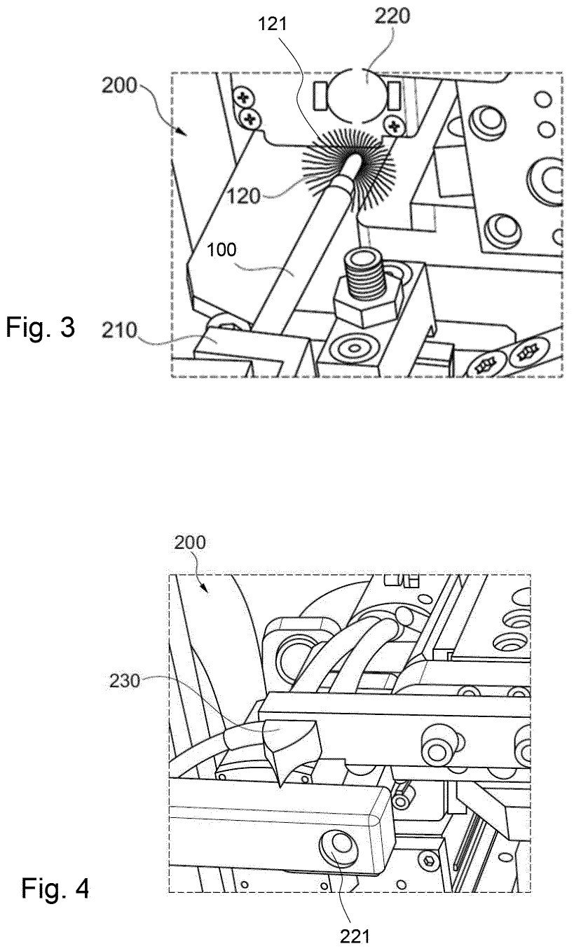

A device 200 for producing the shielded cable 100 will now be described with reference to FIG. 3 to 5.

The device 200 comprises a holding device 210 which is configured to hold the cable 100 at the outer circumference. Furthermore, the device 200 comprises at least one set-up device 220 which is configured to set up the shielding braid 120, which is arranged around an outer circumferential surface of the conductor 110 and has a plurality of shield strands 121, such that a free end of the shielding braid 120 extends away from the conductor 110 in a substantially radial direction. That is to say, the free ends of the shield strands 121 extend radially away from the conductor 100. For this purpose, according to one exemplary embodiment, an iris-like device, shown only schematically, can be used, which applies pressure to the shield strands 121 at several points around the cable 100 in order to bend them open step by step. The iris-like device can be moved along the cable 100 between the individual pressing operations. The shield strands 121 of the shielding braid 120 are unbraided. In a further exemplary embodiment, the shield strands 121 are bent in a different way.

In addition, the device 200 comprises a splitting device 230 which is configured according to the invention to spread apart the shield strands 121 of the set-up free end of the shielding braid 120 in such a way that a gap 122 is formed in the shielding braid 120, which splits the plurality of shield strands 121 and/or spaces them apart from one another in groups.

Furthermore, the device 200 comprises a crimping device 240 which is configured to apply a crimp sleeve 130 around the outer circumferential surface of the conductor 110 and around the shielding braid 120 such that the joining portion 132 is formed between the crimping flanks 131 of the crimp sleeve 130 in the region of the gap 122 in the shielding braid 120, and to then crimp the crimp sleeve 130.

In FIG. 3, the cable 100 is held in the holding device 210 and the free end of the shielding braid 120 has been set up by the set-up device 220 by moving the shielding braid 120 and the set-up device 220 towards each other and thus deforming the shielding braid into the shape shown in FIG. 3, e.g., by bending it. This can be done by stripping or block driving and/or as described above by stepwise radial pressing along the circumference of the cable 100. In a further exemplary embodiment, the shielding braid 120 can also be set up in a different way, for example by means of compressed air.

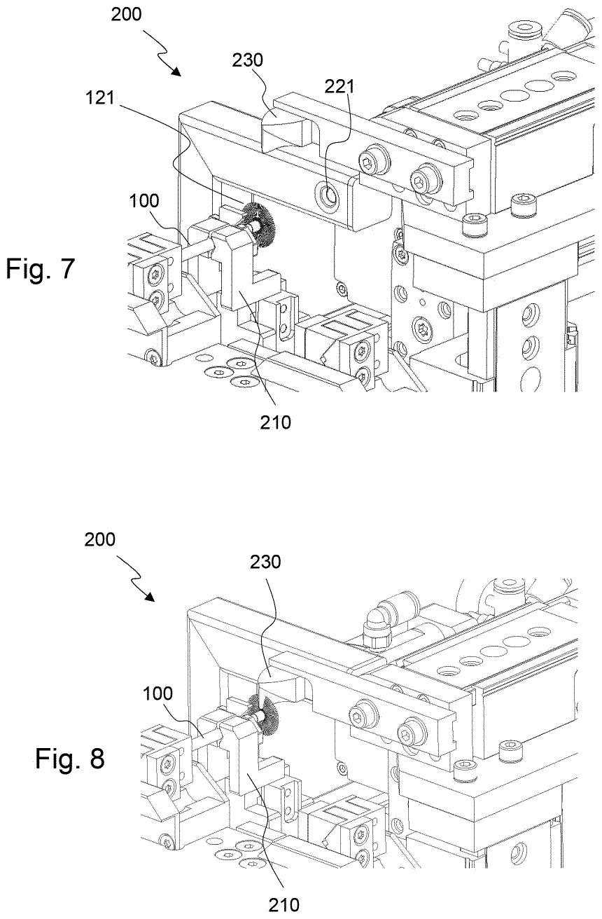

FIG. 4 shows a perspective view of the splitting device 230 with which the gap 122 can be formed in the shielding braid 120. The splitting device 230 has a bow shape, wherein the splitting device 230 is configured to be inserted into the free end of the shielding braid 120 with a bow tip of the bow first or to dip therein in order to spread apart the set up shielding braid 120 and thereby form the gap 122. A schematic representation of the shield strands 121 having been spread apart is described in detail in FIG. 7.

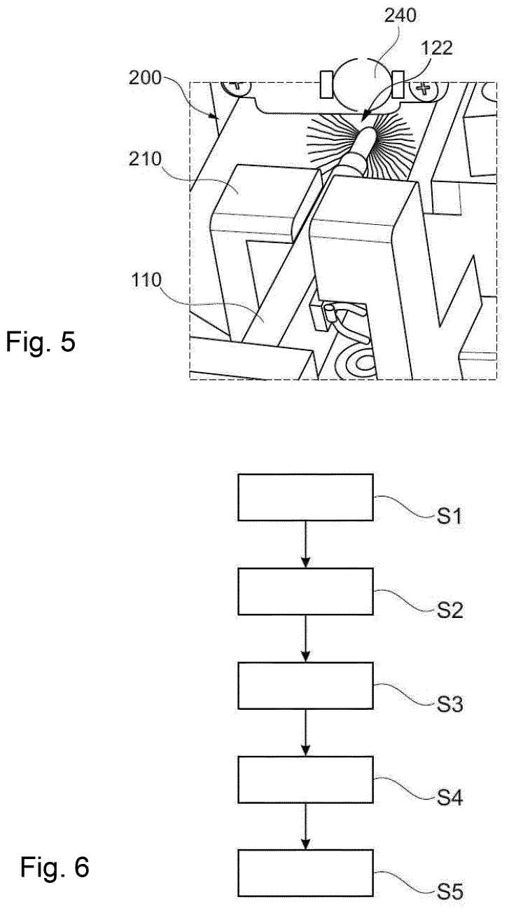

In FIG. 5, the cable 100 is shown in the holding device 210 after the formation of the gap 122. It can be seen that the plurality of shield strands 121 are divided by the deformation into a first subgroup extending over a first arc portion of the outer peripheral surface of the conductor 110 and a second subgroup extending over a second arc portion of the outer peripheral surface of the conductor 110, and the gap 122 between the first and second subgroups extends over a third arc portion of the outer peripheral surface of the conductor 110. The two subgroups join on the other side of cable 100. This means that the set-up shield strands 121 have a substantially uniform distribution over the circumference of the cable 100, which is interrupted in a wedge shape at the gap 122. In a further exemplary embodiment, the shield strands 121 are not substantially evenly distributed. In this case, the two subgroups do not join and additional gaps appear in other places.

In FIG. 5, the crimping device 240 is also schematically indicated, with which the crimp sleeve 130 can be crimped onto the cable 100. Previously, the shielding braid 120 provided with the gap 122 can be folded over or turned inside out lengthwise parallel to the cable 110 by means of a stripping device 221, see for example FIG. 7. In the described exemplary embodiment, the stripping device 221 is a hole-like device that can be pushed over the cable 100 with little play relative to the outer layer. In a further exemplary embodiment, the stripping device 221 may be the set-up device 220 or a part thereof. In yet another embodiment, the stripping device comprises the crimp sleeve 130 and the crimp sleeve 130 is applied to the cable 100 in such a way that the shielding braid 120 is folded over or turned inside out.

A method for producing the shielded cable 100 will now be explained with reference to FIG. 6, which shows a flow chart. The method can be carried out with the device 200 described above.

In a step S1, the cable 100 is provided with the conductor 110 having the shielding braid 120 arranged around an outer peripheral surface of the conductor 110 and having a plurality of shield strands 121.

In a step S2, the free end of the shielding braid 120 is set up such that free ends of the shield strands 121 of the shielding braid 120 extend away from the conductor 110 in a substantially radial direction. In this case, the shielding braid 120 is unbraided automatically or by a separate intervention in an additional method step. The separate intervention may involve the use of a brush or comb or compressed air or pressure with an iris-like device as described above. The set-up shield strands 121 can be seen, for example, in FIG. 7. There, the device 200 with the clamped cable 100 is shown. The shield strands 121 have already been set up and the splitting device 230 is positioned for immersion into the set up shield strands 121.

In a step S3, the set-up free end of the shielding braid 120 is spread apart by means of the splitting device 230 such that the gap 122 is formed in the shielding braid 120, which divides the plurality of shield strands 121 and/or spaces them apart from one another in groups. FIG. 8 shows the beginning of the immersion of the splitting device 230 into the set-up shield strands 121. The bow tip already protrudes between the shield strands 121 and during a further movement of the splitting device 230 along the longitudinal axis of the cable 100, the shield strands 121 are subsequently spread apart.

According to the invention, it is irrelevant whether the bow tip is inserted laterally-as shown in the transition from FIG. 7 to FIG. 8, or whether the bow tip is inserted axially (i.e., parallel to the conductor 110) into the set-up shield strands.

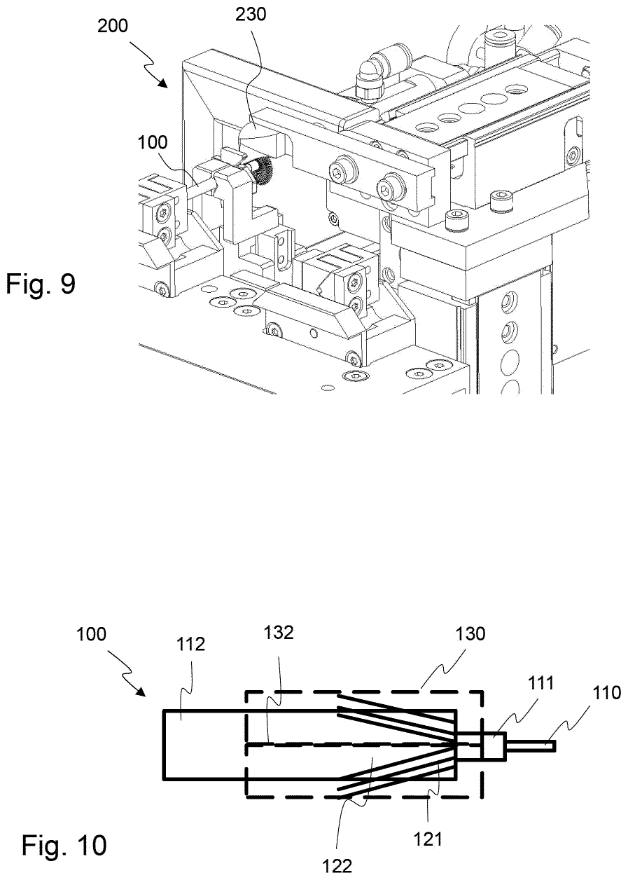

FIG. 9 shows a state following the state of the method according to FIG. 8, in which the splitting device 230 has already been inserted further into the set-up shield strands 121. Due to the bow shape of the splitting device 230, the shield strands 121 were spread out and in the area of the bow tip, i.e., starting from the edge of the splitting device 230, the shield strands are widened, i.e., bent apart laterally.

In a step S4, after the splitting device 230 has been removed, the crimp sleeve 130 is applied around the outer circumferential surface of the conductor 110 and around the shielding braid 120 such that the crimping flanks 131 of the crimp sleeve 130 come to lie in the region of the gap 122 of the shielding braid 120. This means that in the radial direction, the gap 122 in the shield strands 121 of the shielding braid 120 is aligned with the opening of the crimp sleeve 130 formed by the distance between the crimp flanks 131. During this step, the free ends of the shield strands 121 are folded over by the crimp sleeve 130 such that the free ends of the shielding braid 120 are directed away from a free end of the conductor 110 in the opposite direction. For this purpose, when crimping the crimp sleeve 130, a slipping movement of the crimp sleeve 130 along the cable 100 away from the free end, i.e., behind the free end of the cable 100, can take place.

In a further exemplary embodiment, the folding-over of the shield strands 121 is carried out by the stripping device 221, which is different from the crimp sleeve and can be a separate device or part of the set-up device 220. In this case, this step takes place before applying the crimp sleeve 130.

In a step S5, the crimp sleeve 130 is crimped onto the cable 100 by means of the crimping device 240. In this case, the crimp flanks 131 are brought together in the region of the gap 122, so that the joining portion 132 is arranged in a region of the cable 100 in which a small number of shield strands 121 are arranged, as can be seen, for example, in FIG. 1. The finished cable 100 corresponds to the representation in FIG. 2.

FIG. 10 shows a schematic representation of the cable 100 according to an exemplary embodiment with bent-over shield strands 121. The cable 100 has the conductor 110 which is surrounded by the insulator 111. The shielding braid 120 has already been unbraided and the shield strands 121 have been folded over the outer layer 112. Here, the gap 122 can be seen, which was formed by the spreading apart of the shield strands 121. The gap 122 widens wedge-shaped along the longitudinal axis of the cable 100 as seen from the free end of the cable 100. In a further exemplary embodiment, the outer layer 112 has been removed from the conductor 100 over a predetermined length from the free end of the cable 100 and the shield strands 121 are folded over so that they come to lie on the uncut shielding braid 120.

The crimped crimp sleeve 130 is indicated by dashed lines in FIG. 10, with the joining portion 132 being arranged in the region of the gap 122. Here, the crimp flanks 131 are shown straight. In a further exemplary embodiment, they can be structured as shown, for example, in FIGS. 1 and 2. By flaring the shield strands 121 and arranging the joining portion 132 in the region of the gap 122, few or no shield strands 121 are clamped in the crimp sleeve 131 during pressing or crimping of the crimp sleeve 130.

1. A method for producing a shielded cable, comprising the steps of:
providing a conductor with a shielding braid arranged around an outer peripheral surface of the conductor and having a plurality of shield strands,
opening the shielding braid so that the shield strands of the shielding braid are no longer braided in the region of a free end of the shield strands,
setting up the free end of the shield strands of the opened shielding braid such that the free end extends away from the conductor in a substantially radial direction,
spreading apart the set-up free end of the shielding braid by means of a splitting device such that a gap is formed in the shielding braid, which gap divides the plurality of shield strands and/or spaces them apart from one another in groups,
applying a crimp sleeve around the outer circumferential surface of the conductor and around the shielding braid such that a joining portion between two free radial ends of the crimp sleeve comes to lie in the region of the gap of the shielding braid, and
crimping the applied crimp sleeve using a crimping tool.

2. The method of claim 1, wherein the plurality of shield strands are divided by the spreading apart into a first subgroup extending over a first arc portion of the outer peripheral surface of the conductor and a second subgroup extending over a second arc portion of the outer peripheral surface of the conductor, and the gap between the first and second subgroups extends over a third arc portion of the outer peripheral surface of the conductor.

3. The method according to claim 1, further comprising the step of:
folding over the free end of the shielding braid with gap such that the free ends of the shielding braid are directed away from a free end of the conductor.

4. The method according to claim 1, wherein the free ends of the shield strands of the shielding braid are positioned at a substantially perpendicular angle to a longitudinal extension direction of the conductor.

5. The method according to claim 1, wherein the splitting device has a bow shape, and wherein the splitting device is inserted with a tip of the bow first between the free ends of the shield strands of the shielding braid.

6. The method according to claim 1, wherein the crimp sleeve in conjunction with the shielding braid forms an outer conductor of the cable or a part of the outer conductor.

7. The method according to claim 1, further comprising the step:
after crimping the crimp sleeve, optically inspecting the joining portion for shield strands protruding between the two free radial ends of the crimp sleeve and/or other processing errors.

8. A device for producing a shielded cable, comprising:
a holding device which is configured to hold the shielded cable at its outer circumference,
at least one set-up device which is configured to set up a shielding braid which is arranged around an outer circumferential surface of a conductor of the shielded cable and has a plurality of shield strands in such a way that free ends of the shield strands of the shielding braid extend away from the conductor in a substantially radial direction,
a splitting device which is configured to spread apart the set-up free ends of the shield strands in such a way that a gap is formed in the shielding braid, which gap divides the plurality of shield strands and/or spaces them apart from one another in groups, and
a crimping device which is configured to apply a crimp sleeve around the outer circumferential surface of the conductor and around the shielding braid in such a way that a joining portion between two free radial ends of the crimp sleeve comes to lie in the region of the gap in the shielding braid, and to crimp the crimp sleeve.

9. The device according to claim 8, wherein the splitting device has a bow shape, and the splitting device is configured to be inserted into the free end of the shielding braid with a bow tip of the bow first.

10. The device according to claim 8, comprising a stripping device which is configured to fold over the free end of the shield strands of the shielding braid with gap in such a way that the free ends of the shield strands of the shielding braid are directed in the opposite direction away from a free end of the conductor.

11. A splitting device for producing a shielded cable, comprising:
a holding device which is configured to hold at its outer circumference,
at least one set-up device which is configured to set up shielding braid which is arranged around an outer circumferential surface of a conductor of the shielded cable and has a plurality of shield strands in such a way that free ends of the shield strands of the shielding braid extend away from the conductor in a substantially radial direction,
a splitting device which is configured to spread apart the set-up free ends of the shield strands in such a way that a gap is formed in the shielding braid, which gap divides the plurality of shield strands and/or spaces them apart form one another in groups, and
a crimping device which is configured to apply a crimp sleeve around the outer circumferential surface of the conductor and around the shielding braid in such a way that a joining portion between two free radial ends of the crimp sleeve comes to lie in the region of the gap in the shielding braid, and to crimp the crimp sleeve, wherein the splitting device has a bow shape which is designed such that the splitting device tapers concavely to a point along a bow tip and preferably has a convex transition from the bow tip to the component width of the splitting device.

12. The method according to claim 2, further comprising the step of:
folding over the free end of the shielding braid with gap such that the free ends of the shielding braid are directed away from a free end of the conductor.

13. The method according to claim 2, wherein the free ends of the shield strands of the shielding braid are positioned at a substantially perpendicular angle to a longitudinal extension direction of the conductor.

14. The method according to claim 2, wherein the splitting device has a bow shape, and wherein the splitting device is inserted with a tip of the bow first between the free ends of the shield strands of the shielding braid.

15. The method according to claim 2, wherein the crimp sleeve in conjunction with the shielding braid forms an outer conductor of the cable or a part of the outer conductor.

16. The method according to claim 2, further comprising the step:
after crimping the crimp sleeve, optically inspecting the joining portion for shield strands protruding between the two free radial ends of the crimp sleeve and/or other processing errors.

17. The device according to claim 9, comprising a stripping device which is configured to fold over the free end of the shield strands of the shielding braid with gap in such a way that the free ends of the shield strands of the shielding braid are directed in the opposite direction away from a free end of the conductor.
